(19) United States
(12) Patent Application Publication
(10) Pub. No.: US 2007/0236910 A1
(43) Pub. Date: Oct. 11, 2007

(54) COVERING MEMBER FOR DISPLAY DEVICE, DISPLAY DEVICE HAVING THE SAME, AND METHOD THEREOF

(75) Inventors: Su-Young YUN, Cheonan-si (KR); Won-Ju KIM, Yongin-si (KR); Jae-Hwan CHUN, Suwon-si (KR); Min-Ho OK, Hwaseong-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/696,788

(22) Filed: Apr. 5, 2007

(30) Foreign Application Priority Data
Apr. 6, 2006 (KR) 10-2006-0031200

(51) Int. Cl. G01D 11/28

(52) U.S. Cl. 362/29; 362/631; 362/633; 362/606

(57) ABSTRACT

A covering member for a display device includes a supporting part, a sidewall part and a plurality of contact parts. The supporting part is extended along a surface of the display device. The sidewall part is extended from the supporting part along a side surface of the display device, and an opening is formed at the sidewall part. A plurality of contact parts is inclined with respect to the sidewall part and extended from an edge of the opening, each of the contact parts bent a plurality of times. Contact parts contact another component of the display device. Therefore, the number of components of the display device is reduced, so that the manufacturing process of the display device may be simplified.

This application claims priority to Korean Patent Application No. 2006-0031200, filed on Apr. 6, 2006 and all the benefits accruing therefrom under 35 U.S.C. §119, and the contents of which in its entirety are herein incorporated by reference.

### BACKGROUND OF THE INVENTION

1. Field of the Invention

The present invention relates to a covering member for a display device, a display device having the covering member, and a method thereof. More particularly, the present invention relates to a covering member electrically grounding static electricity and electromagnetic waves of a display device, a display device having the covering member, and a method of grounding static electricity and electromagnetic waves of the display device.

2. Description of the Related Art

In general, a display device includes a liquid crystal display (“LCD”) panel, a printed circuit board (“PCB”), and a backlight assembly. The LCD panel includes an array substrate, an opposite substrate facing the array substrate, and a liquid crystal layer disposed between the array substrate and the opposite substrate. The PCB drives the LCD panel. The backlight assembly provides light to the LCD panel.

The array substrate includes signal wirings such as a plurality of gate wirings and a plurality of data wirings and a switching device such as a thin film transistor (“TFT”) electrically connected to one of the gate wirings and one of the data wirings.

A plurality of circuit devices is mounted on the PCB, and the PCB is electrically connected to the LCD panel through a flexible printed circuit (“FPC”) film. The FPC film is electrically connected to the signal wirings. A lot of electromagnetic waves are generated when the PCB drives the LCD panel.

The backlight assembly includes a light source and a power supply part, and a lot of electromagnetic waves are also generated from the light source and the power supply part.

Static charges are generated on the LCD panel during the manufacturing processes of the LCD panel, for example, during formation of an active layer, adhesion and removal of a protective film for protecting the LCD panel, and so on. Moreover, the static charge may also be generated in the LCD panel by an influx of unnecessary electromagnetic waves from an exterior of the LCD panel.

When the static charge and the electromagnetic waves are not effectively grounded, an image display quality of the LCD panel is deteriorated, and wiring defects such as a disconnection and a short of wirings formed in the PCB may be caused and damages of the circuit devices by an electrical shock may be caused.

Contact members are disposed between receiving containers, and electrically ground the receiving containers to each other for electrically grounding the static electricity and the electromagnetic waves. However, when the display device includes the extra contact members, the number of components of the display device is increased and additional manufacturing processes are required.

### BRIEF SUMMARY OF THE INVENTION

The present invention provides a covering member for a display device, which has contact parts integrally formed therewith.

The present invention also provides a display device having the above-mentioned covering member.

The present invention also provides a method of grounding static electricity and electromagnetic waves of the display device.

In aspects of the present invention in accordance with exemplary embodiments, a covering member for a display device includes a supporting part, a sidewall part, and a plurality of contact parts. The supporting part is extended along a surface of the display device. The sidewall part is extended from the supporting part along a side surface of the display device, and an opening is formed at the sidewall part. A plurality of contact parts is inclined with respect to the sidewall part and extended from an edge of the opening, each of the contact parts bent a plurality of times.

The supporting part covers edges of a display panel of the display device. The opening is formed between an upper portion of the sidewall part connected to the supporting part and a lower portion of the sidewall part facing the upper portion of the sidewall part. The contact parts may be extended from an upper edge of the opening adjacent to the upper portion of the sidewall part or from a lower edge of the opening adjacent to the lower portion of the sidewall part. Each of the contact parts includes a supporting protrusion, a contact protrusion and a guide protrusion. The supporting protrusion may be inclined with respect to the sidewall part and extended from an edge of the opening to an inside of a receiving space defined by the supporting part and the sidewall part. The contact protrusion extended from the supporting protrusion is substantially parallel with the sidewall part. The guide protrusion inclined with respect to the sidewall part is extended toward the sidewall part.

In accordance with other exemplary embodiments, the supporting part may cover a rear surface of a backlight assembly of the display device.

The plurality of contact parts may be integrally formed with the sidewall part and have resiliency with respect to the sidewall part.

In other aspects of the present invention in accordance with exemplary embodiments thereof, a display device includes a display panel, a backlight assembly, a first covering member, and a second covering member. A display area and a peripheral area surrounding the display area are defined in the display panel. The backlight assembly supplies light into a rear surface of the display panel. The first covering member receives the display panel and the backlight assembly. The first covering member includes a first supporting part and a first sidewall part. The first supporting part supports the display panel and the backlight assembly. The first sidewall part is extended from the first supporting part along sides of the display panel and the backlight assembly. The second covering member receives the display panel and the backlight assembly. The second covering member includes a second supporting part, a second sidewall part, and a plurality of contact parts. The second supporting part corresponds to the first supporting part and supports the display panel and the backlight assembly. The second sidewall part is extended from the second supporting part along the first sidewall part and has an opening. A plurality of contact parts is extended from an edge of the opening, and each contact part is bent a plurality of times to contact the first sidewall part.

In accordance with exemplary embodiments thereof, the first supporting part covers a rear surface of the backlight assembly, and the second supporting part and the second sidewall part cover the peripheral area of the display panel and the first sidewall part, respectively. The display device may further include a printed circuit board (“PCB”) and a contact member. The PCB drives the display panel, and the contact member is disposed on the PCB and contacts the first or second covering member. Each of the contact parts includes a supporting protrusion, a contact protrusion, and a guide protrusion. The supporting protrusion is inclined with respect to the second sidewall part and is extended from an edge of the opening toward the first sidewall part. The contact protrusion is extended from the supporting protrusion and is substantially parallel with the first sidewall part to make a surface contact with the first sidewall part. The guide protrusion is extended from the contact protrusion toward the second sidewall part. The backlight assembly includes a light source and an optical unit. The light source is disposed on the first supporting part, and the optical unit is supported by the first sidewall part. The display device may further include a middle mold frame covering a peripheral area of the optical unit extended between the first and second sidewall part.

In other exemplary embodiments, the backlight assembly includes a light guide plate, a light source, and an optical unit. The light guide plate is disposed on the first supporting part, and the light source is disposed at a side of the light guide plate, and an optical unit is disposed on the light guide plate.

In other exemplary embodiments, the second supporting part covers a rear surface of the backlight assembly, and the first supporting part and the first sidewall part covers the peripheral area of the display panel and the second sidewall part, respectively.

The plurality of contact parts may be integrally formed with the second sidewall part and may have resiliency with respect to the second sidewall part. The first covering member and the second covering member may be physically and electrically connected to each other through at least the plurality of contact parts and a static charge or an electromagnetic wave applied to at least one of the first covering member and the second covering member is grounded.

According to other exemplary embodiments of the present invention, a method of grounding a static charge or an electromagnetic wave applied to a covering member of a display device includes integrally forming a plurality of contact members from an opening in a sidewall part of the covering member, the plurality of contact members formed with a plurality of bends and resiliency with respect to the sidewall part, combining the covering member with an electrically conductive component of the display device, and physically and electrically contacting the covering member to the component through at least the plurality of contact members. The covering member and the component may enclose a display panel and a backlight assembly of the display device therein.

According to the covering member for a display device, the receiving container and the display device having the covering member, the number of the contact member is reduced, so that the number of components of the display device is reduced. Therefore, manufacturing process of the display device may be simplified.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a perspective view illustrating an exemplary covering member for an exemplary display device in accordance with exemplary embodiments of the present invention;

FIG. 2 is an enlarged perspective view illustrating an exemplary contact part of the exemplary covering member for the exemplary display device in FIG. 1;

FIG. 3 is a cross-sectional view taken along line I-I′ of the exemplary covering member for the exemplary display device in FIG. 1;

FIG. 4 is a perspective view illustrating an exemplary covering member for an exemplary display device in accordance with another exemplary embodiment of the present invention;

FIG. 5 is an enlarged perspective view illustrating an exemplary contact part of the exemplary covering member for an exemplary display device in FIG. 4;

FIG. 6 is a cross-sectional view taken along line II-II′ of the exemplary covering member for the exemplary display device in FIG. 4;

FIG. 7 is a perspective view illustrating an exemplary covering member for an exemplary display device in accordance with another exemplary embodiment of the present invention;

FIG. 8 is an exploded perspective view illustrating an exemplary covering member for an exemplary display device in accordance with another exemplary embodiment of the present invention;

FIG. 9 is a cross-sectional view taken along line III-III′ of the exemplary display device in FIG. 8;

FIG. 10 is a cross-sectional view illustrating an exemplary display device in accordance with another exemplary embodiment of the present invention;

FIG. 11 is an exploded perspective view illustrating an exemplary display device in accordance with another exemplary embodiment of the present invention;

FIG. 12 is a cross-sectional view taken along line IV-IV′ of the exemplary display device in FIG. 11;

FIG. 13 is an exploded perspective view illustrating an exemplary display device in accordance with another exemplary embodiment of the present invention; and

FIG. 14 is a cross-sectional view taken along line V-V′ of the exemplary display device in FIG. 13.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

Covering Member in Display Device

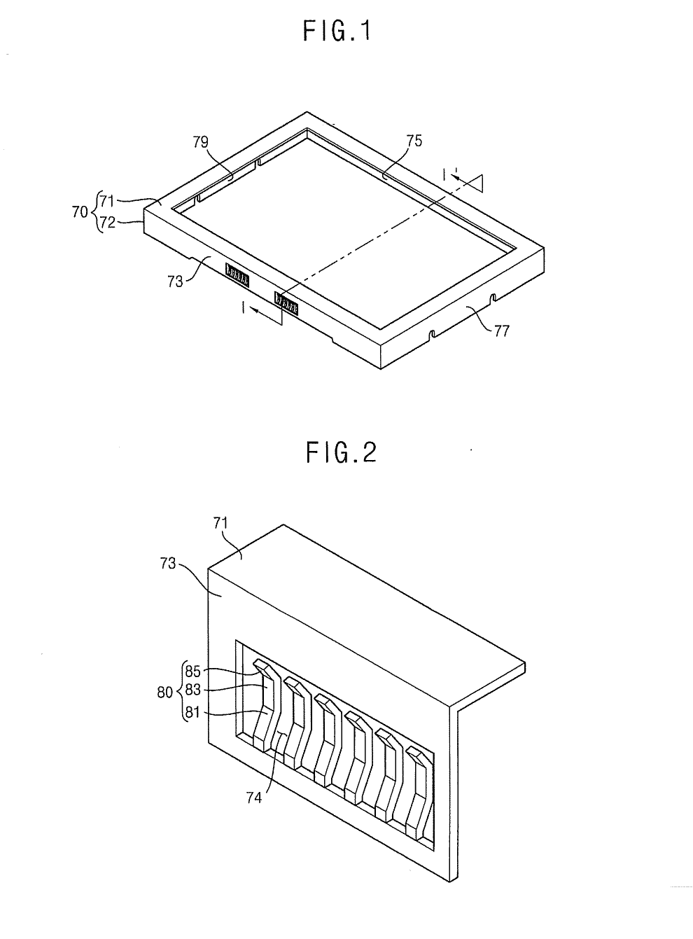

FIG. 1 is a perspective view illustrating an exemplary covering member for an exemplary display device in accordance with an exemplary embodiment of the present invention. FIG. 2 is an enlarged perspective view illustrating an exemplary contact part of the exemplary covering member for the exemplary display device in FIG. 1. A covering member 70 for a display device covers at least portions of front and rear surfaces of the display device having a display panel and a backlight assembly emitting light into the display panel.

Referring to FIGS. 1 and 2, the covering member 70 for the display device fixes the display panel to a bottom chassis receiving the backlight assembly. The covering member 70 for the display device includes metal that has sufficient rigidity. The covering member 70 includes a supporting part 71, a sidewall part 72 and a plurality of contact parts 80.

An effective display area and a peripheral area surrounding the effective display area are defined on the display panel. The supporting part 71 covers the peripheral area. The shape of the supporting part 71 corresponds to the shape of the display panel. For example, the supporting part 71 has a substantially rectangular shape, although other shapes are within the scope of these embodiments.

The sidewall part 72 is extended from the supporting part 71 along sides of the display panel. The sidewall part 72 is combined with a middle mold frame of the display device or a sidewall part of the bottom chassis. The sidewall part 72 includes first, second, third, and fourth side walls 73, 75, 77, and 79.

The first, second, third, and fourth sidewalls 73, 75, 77, and 79 are respectively extended from four edges of the supporting part 71. The first, second, third, and fourth sidewalls 73, 75, 77, and 79 are substantially in perpendicular to the supporting part 71. Therefore, the supporting part 71 and sidewall part 72 form a receiving space for receiving the display panel.

An opening 74 is formed in at least one of the first, second, third, and fourth side walls 73, 75, 77, and 79. For example, two openings 74 are formed in the first sidewall 73, although an alternate number of openings may be formed in any of the sidewalls. The openings 74 are formed between an upper portion of the sidewall part 72 connected to the supporting part 71 and a lower portion of the sidewall part 72 facing the upper portion. The contact parts 80 may be extended from an upper edge of the opening 74 adjacent to the upper portion of the sidewall part 72 or may alternatively be extended from a lower edge of the opening 74 adjacent to the lower portion of the sidewall part 72.

In FIGS. 1 and 2, the contact parts 80 are, by example, extended from the lower edge of the opening 74. The contact parts 80 are inclined with respect to the first sidewall 73, and are bent for a plurality of times to face the first sidewall 73. In another embodiment, the contact parts 80 may be extended from the upper edge of the opening 74.

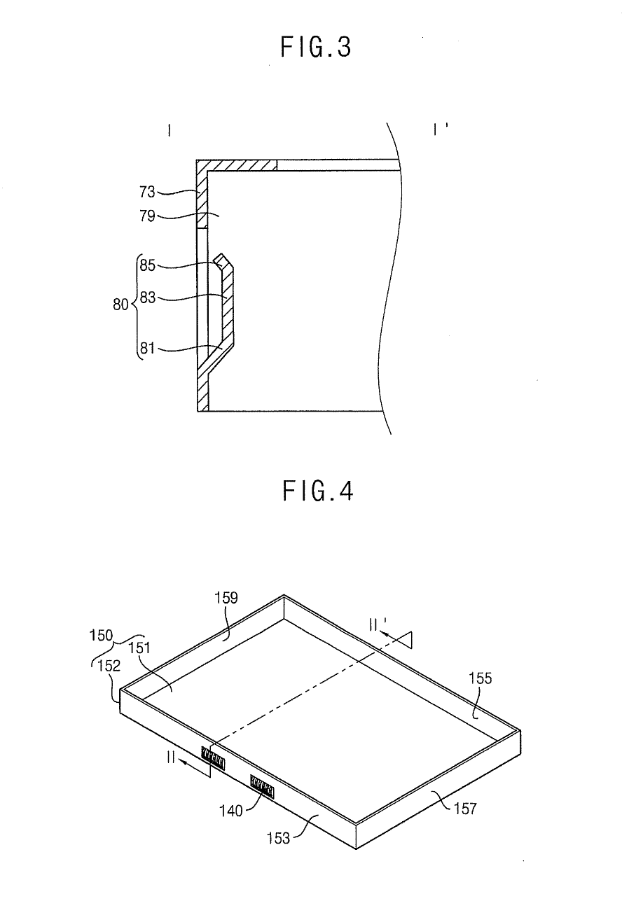

FIG. 3 is a cross-sectional view taken along line I-l′ of the exemplary covering member for the exemplary display device in FIG. 1.

Referring to FIGS. 2 and 3, each of the contact parts 80 includes a supporting protrusion 81, a contact protrusion 83, and a guide protrusion 85. The supporting protrusion 81 is inclined with respect to the sidewall part 72, and is extended to an interior of the receiving space defined by the supporting part 71 and the sidewall part 72. The contact protrusion 83 is extended from the supporting protrusion 81 towards the supporting part 71 and substantially in parallel with the first sidewall 73. The guide protrusion 85 is extended from the contact protrusion 83 towards the first sidewall part 73, and is inclined with respect to the first sidewall 73.

The covering member 70 makes contact with another component of the display device, for example, the bottom chassis through the contact parts 80. The bottom chassis includes metal having electrically conductive characteristics, so that the covering member 70 and the bottom chassis are connected physically and electrically via the contact parts 80. Therefore, the static charge and the electromagnetic wave applied to the covering member 70 or the static charge and the electromagnetic wave applied to the bottom chassis are grounded so that a display quality deterioration of the display panel and damage of the circuit devices are prevented.

The contact parts 80 are integrally formed with the sidewall part 72, so that the covering member 70 may be electrically grounded to another component such as the bottom chassis. Moreover, each of the contact parts 80 is bent for a plurality of times, and makes contact with another component. Each of the contact parts 80 has an elastic structure to be resistant to deformation and to recover after the deformation. Moreover, the contact protrusion 83 of the contact part 80 makes contact with other components, and a contact area between the contact part 80 and the other component increases. The number of contact parts 80 provided within each opening 74 may vary depending on a size of the display device. Also, the contact parts 80 may be separated from each other by spaces to further ensure contact of the contact parts 80 of the covering member 70 with a surface of another component.

FIG. 4 is a perspective view illustrating an exemplary covering member for an exemplary display device in accordance with another exemplary embodiment of the present invention. FIG. 5 is an enlarged perspective view illustrating an exemplary contact part of the exemplary covering member for an exemplary display device in FIG. 4.

Referring to FIGS. 4 and 5, a covering member 150 for a display device receives a backlight assembly. The covering member 150 for the display device includes metal that has sufficient rigidity, and includes a supporting part 151, a sidewall part 152 and a plurality of contact parts 140.

The backlight assembly is disposed in the supporting part 151. The supporting part 151 covers at least portions of a rear surface of the backlight assembly. The sidewall part 152 is extended from an edge of the supporting part 151 along a side surface of the backlight assembly. The supporting part 151 has a substantially rectangular shape, although other shapes are within the scope of these embodiments. The sidewall part 152 includes first, second, third, and fourth sidewalls 153, 155, 157, and 159 extended from four edges of the supporting part 151. The first, second, third, and fourth sidewalls 153, 155, 157, and 159 are substantially perpendicular to the supporting part 151. Therefore, the supporting part 151 and sidewall part 152 form a receiving space receiving the backlight assembly.

The contact parts 140 are extended from the sidewall part 152. The contact parts 140 are bent for a plurality of times, and are protruded from outside of the receiving space defined by the supporting part 151 and sidewall part 152. That is, the contact parts 140 are protruded away from the receiving space defined by the supporting part 151 and sidewall part 152. The covering member 150 for the display device makes contact with other components of the display device, for example, a top chassis covering the display panel through the contact parts 140. The top chassis includes metal having electrical conductivity. Therefore, the covering member 150 for the display device and the top chassis are physically and electrically connected via the contact parts 140.

Therefore, the static charge and the electromagnetic wave applied to the covering member 150 or the top chassis are grounded, and display quality deterioration of the display panel and damage of the circuit devices by the static electricity and the electromagnetic waves are prevented.

The contact parts 140 are formed on at least one of the first, second, third, and fourth sidewalls 153, 155, 157, and 159. For example only, the contact parts 140 are formed in the first sidewall 153. An opening 154 is formed in the first sidewall 153. The contact parts 140 are extended from an edge of the opening 154. A plurality of the openings 154 having the contact parts 140 may be formed on the first sidewall 153. For example, two openings 154 are formed in the first sidewall 153, however an alternate number of openings may be formed on any of the first, second, third, and fourth sidewalls 153, 155, 157, and 159.

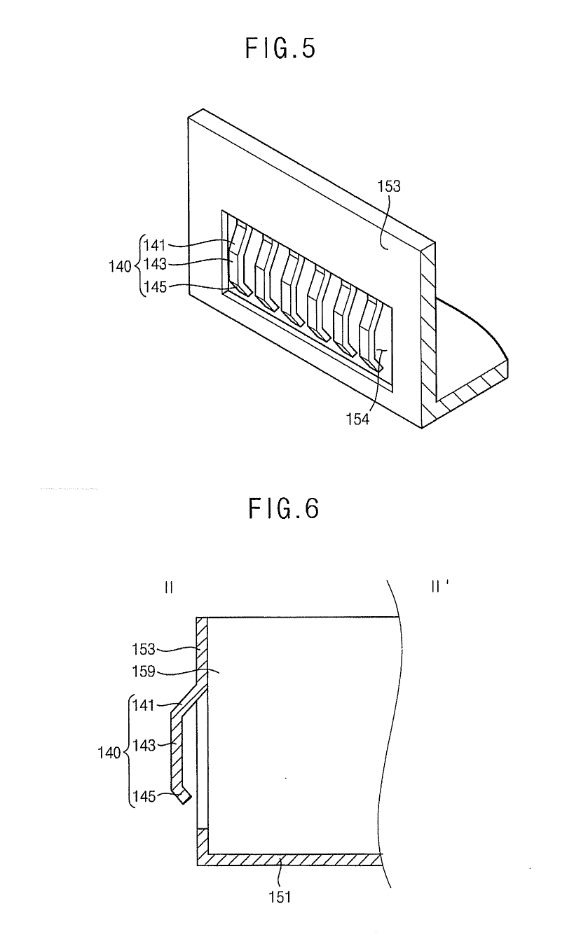

FIG. 6 is a cross-sectional view taken along line II-II′ of the exemplary covering member for the exemplary display device in FIG. 4.

Referring to FIGS. 5 and 6, the opening 154 includes a lower edge adjacent to the supporting part 151 and an upper edge facing the lower edge. The contact parts 140 may be extended from the upper edge or the lower edge of the opening 154. As illustrated, the contact parts 140 may be extended from the upper edge of the opening 154.

Each of the contact parts 140 includes a supporting protrusion 141, a contact protrusion 143, and a guide protrusion 145. The supporting protrusion 141 is extended from the upper edge to an exterior of the receiving space in an inclined direction with respect to the first sidewall 153. The contact protrusion 143 is extended from the supporting protrusion 141 toward the supporting part 151 substantially in parallel with the first sidewall 153. The guide protrusion 145 is extended from the contact protrusion 143 toward the first sidewall 153 in an inclined direction with respect to the first sidewall 153.

The number of contact parts 140 provided within each opening 154 may vary depending on a size of the display device. Also, the contact parts 140 may be separated from each other by spaces to further ensure contact of the contact parts 140 of the covering member 150 with a surface of another component.

Display Device

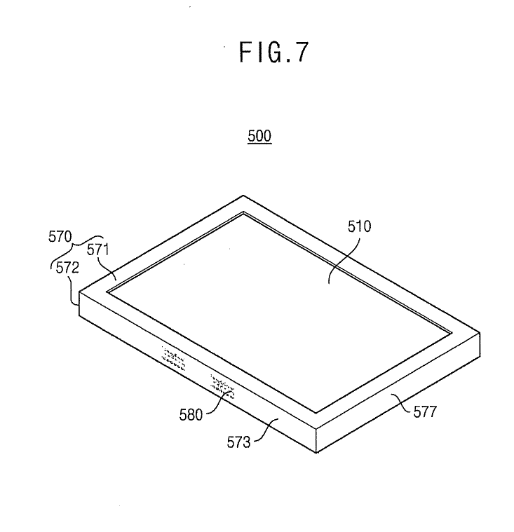

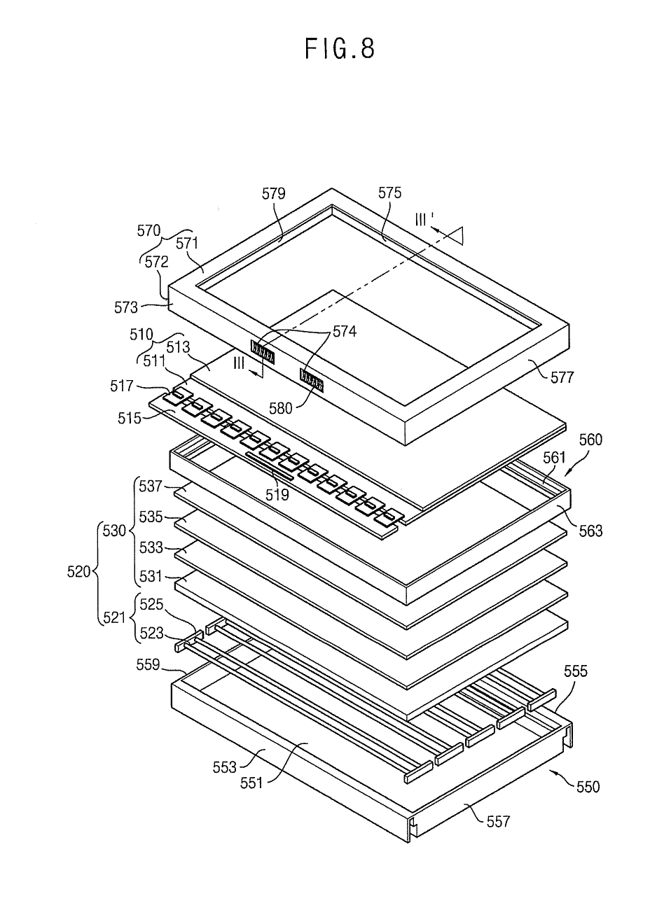

FIG. 7 is a perspective view illustrating an exemplary covering member for an exemplary display device in accordance with another exemplary embodiment of the present invention. FIG. 8 is an exploded perspective view illustrating an exemplary covering member for an exemplary display device in accordance with another exemplary embodiment of the present invention.

Referring to FIGS. 7 and 8, a display device 500 includes a display panel 510, a backlight assembly 520, a first covering member 550, and a second covering member 570.

The display panel 510 displays an image based on light emitted from the backlight assembly 520. The display panel 510 includes a first substrate 511, a second substrate 513 facing the first substrate 511, and a liquid crystal layer (not shown) disposed between the first substrate 511 and the second substrate 513. A display area and a peripheral area surrounding the display area are defined on the display panel 510.

The backlight assembly 520 is disposed at the rear surface of the display panel 510, and emits light into the rear surface of the display panel 510. The backlight assembly 520 includes a light source 521 and an optical unit 530.

The light source 521 includes a plurality of lamps 523 emitting the light and a plurality of lamp holders 525. The lamps 523, for example, may be a cold cathode fluorescent lamp (“CCFL”). Two of the lamps 523 are inserted into each of the lamp holders 525. Each of the lamps 523 receives a power voltage through each of the lamp holders 525 from an exterior source to emit the light. While lamps are described for the light source 521, it should be understood that alternate light sources, such as, but not limited to, light emitting diodes (“LEDs”), ambient light, etc. may be employed in the LCD.

The display device 500 may further include a power supply part (not shown) applying the power voltage to the lamp holders 525. When the power supply part drives the lamps 523 to generate the light, a lot of electromagnetic waves are generated from the power supply part and the lamps 523.

The optical unit 530 is disposed between the lamps 523 and the display panel 510. The optical unit 530 improves optical characteristics of the light emitted from the lamps 523, and emits the light into the rear surface of the display panel 510. The optical unit 530 includes a diffusive plate 531, a diffusive sheet 533, and two light condensing sheets 535 and 537.

The diffusive plate 531, diffusive sheet 533, and the light condensing sheets 535 and 537 are laminated, in sequence. The diffusive plate 531 diffuses the light emitted by the lamps 523, and emits light in which the brightness uniformity is improved. The diffusive sheet 533 diffuses the light emitted from the diffusive plate 531, and emits light in which the brightness uniformity is improved. The condensing sheets 535 and 537 improve the front brightness of the light exiting from the diffusive sheet 533, and emit light in which the luminance is improved when viewed on a plane.

The first covering member 550 receives the backlight assembly 520 and the display panel 510. The first covering member 550 includes a first supporting part 551 and a first sidewall part.

For example, the first supporting part 551 covers the rear surface of, or portions of, the rear surface of the backlight assembly 520. Hereinafter, the first covering member 550 will be referred to as ‘the bottom chassis’, and the first supporting part 551 will be referred to as ‘the bottom plate’.

The lamps 523 and the lamp holders 525 are disposed on the bottom plate 551. The bottom plate 551 has a substantially rectangular shape or other shape corresponding to a shape of the display panel 510.

The first sidewall part of the bottom chassis 550 is extended along a side of the display panel 510 and the backlight assembly 520. The first sidewall part includes first, second, third, and fourth sidewalls 553, 555, 557, and 559 extended from four edges of the bottom plate 551. The first, second, third, and fourth sidewalls 553, 555, 557, and 559 are formed substantially perpendicular to the bottom plate 551, and support the optical unit 530.

The display device 500 may further include a middle mold frame 560. The middle mold frame 560 covers edges of the optical unit 530, and is combined with the bottom chassis 550. The middle mold frame 560 includes a supporting plate 561 and a combining part 563. The supporting plate 561 has a substantially rectangular shape, and presses edges of the optical unit 530. Stepped portions are formed at the supporting plate 561. The display panel 510 is disposed at the stepped portions of the supporting plate 561. The combining part 563 is extended from the supporting plate 561 along the first, second, third and fourth sidewalls 553, 555, 557, and 559 of the bottom chassis 550.

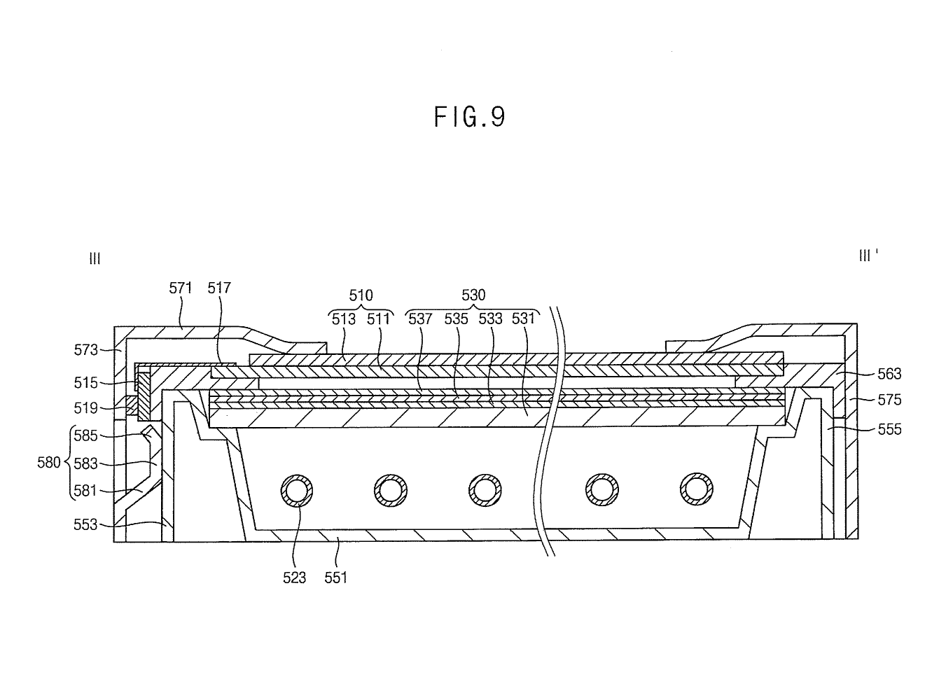

FIG. 9 is a cross-sectional view taken along line III-III′ of the exemplary display device in FIG. 8.

The display device 500 further includes a printed circuit board (“PCB”) 515, a connecting film 517, and a contact member 519.

The PCB 515 drives the display panel 510. The PCB 515 outputs a panel driving signal into the display panel 510. The PCB 515 includes an insulating substrate, a conductive wiring, and circuit devices. A conductive layer formed on the insulating substrate is patterned to form the conductive wiring. The circuit devices are mounted on the insulating substrate, and forms circuit parts by the conductive wiring. When the PCB 515 drives the display panel 510, a lot of electromagnetic waves are generated from the PCB 515. That is, an amount of electromagnetic waves capable of deleteriously affecting the display quality of the display panel 510, if not properly grounded, are generated from the PCB 515.

One edge of the connecting film 517 in a longitudinal direction is electrically connected to one side of the first substrate 511. Another edge of the connecting film 517 in the longitudinal direction facing the one edge is electrically connected to the PCB 515.

The contact member 519 is disposed on the PCB 515. The contact member 519 contacts the first covering member 550 or the second covering member 570 according to a position of the PCB 515. As shown in FIG. 9, the contact member 519 contacts the second covering member 570, and the PCB 515 is grounded to the second covering member 570 through the contact member 519.

The connecting film 517 is disposed along the supporting plate 561 and combining part 563 of the middle mold frame 560, and is bent. The PCB 515 is disposed at a side of the middle mold frame 560 corresponding to a side of the combining part 563.

The second covering member 570 receives the backlight assembly 520 and display panel 510. The second covering member 570 is substantially the same as the covering member 70 shown in FIGS. 1 to 3. The second covering member 570 includes a second supporting part 571, a second sidewall part 572, and a plurality of contact parts 580.

The second supporting part 571 faces the bottom plate 551 of the bottom chassis 550, and supports the display panel 510 and the backlight assembly 520. For example, the second supporting part 571 covers the peripheral area of the display panel 510. Hereinafter, the second covering member 570 will be referred to as the ‘top chassis’.

The second sidewall 572 is extended from the second supporting part 571 along the first sidewall part of the bottom chassis 550. The second sidewall part 572 includes first, second, third, and fourth sidewalls 573, 575, 577, and 579 corresponding to the first, second, third, and fourth sidewalls 553, 555, 557 and 559 of the first sidewall part of the bottom chassis 550. The contact member 519 disposed at the PCB 515 contacts an inside upper portion of the first sidewall 573. Moreover, two openings 574 for the contact parts 580 are formed at the lower portion of the first sidewall 573, although an alternate number of openings and openings within alternate sidewalls of the second sidewall part 572 would also be within the scope of these embodiments.

The contact parts 580 are extended from the edge of the opening 574 in the first sidewall 573 of the top chassis 570 toward the first sidewall 553 of the bottom chassis 550. Each contact part 580 is bent for a plurality of times, and contacts the first sidewall 553. The contact part 580 includes a supporting protrusion 581, a contact protrusion 583, and a guide protrusion 585.

The supporting protrusion 581 is inclined with respect to the first sidewall 573 of the top chassis 570, and is extended from the lower edge of the opening 574 toward the first sidewall 553. The contact protrusion 583 is extended from the supporting protrusion 581 substantially parallel with the first sidewall 573, and contacts the first sidewall 553. The guide protrusion 585 is extended from the contact protrusion 583 towards the first sidewall 573, and is inclined with respect to the first sidewall 553.

When the second sidewall part 572 of the top chassis 570 is combined with the combining part 563 of the middle mold frame 560, the bottom chassis 550 and the top chassis 570 contact each other through the contact parts 580. When the second sidewall part 572 of the top chassis 570 is combined with the first sidewall part of the bottom chassis 550, the contact parts 580 increase a contact area between the bottom chassis 550 and the top chassis 570.

Therefore, the static charge and the electromagnetic wave generated from the backlight assembly 520 and the PCB 515 or the static charge and the electromagnetic wave applied to the display device 500 from an exterior of the display device 500 are electrically grounded, and the display quality deterioration of the display panel 510 and the damage of the circuit devices by the static charge and the electromagnetic wave are prevented.

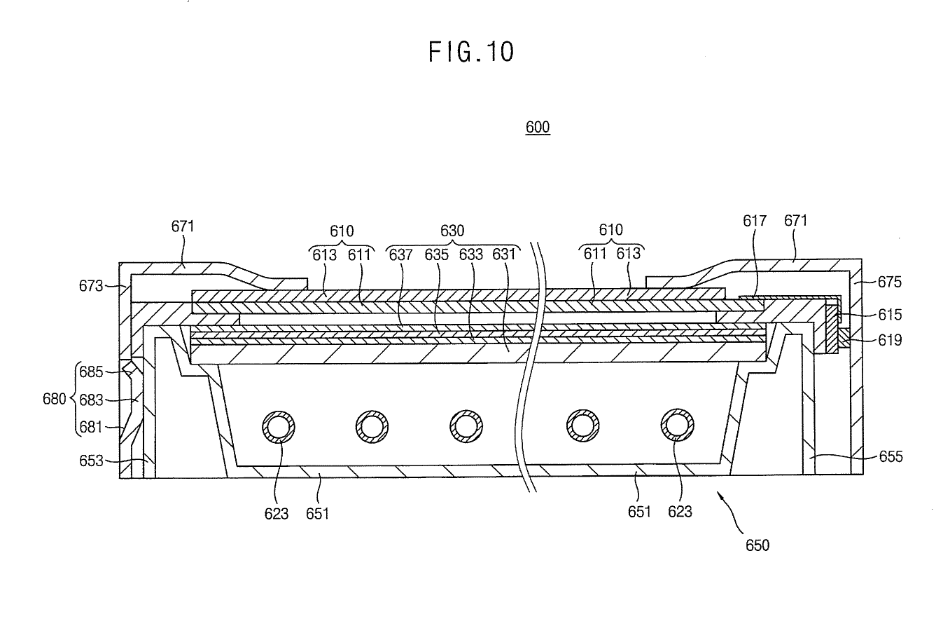

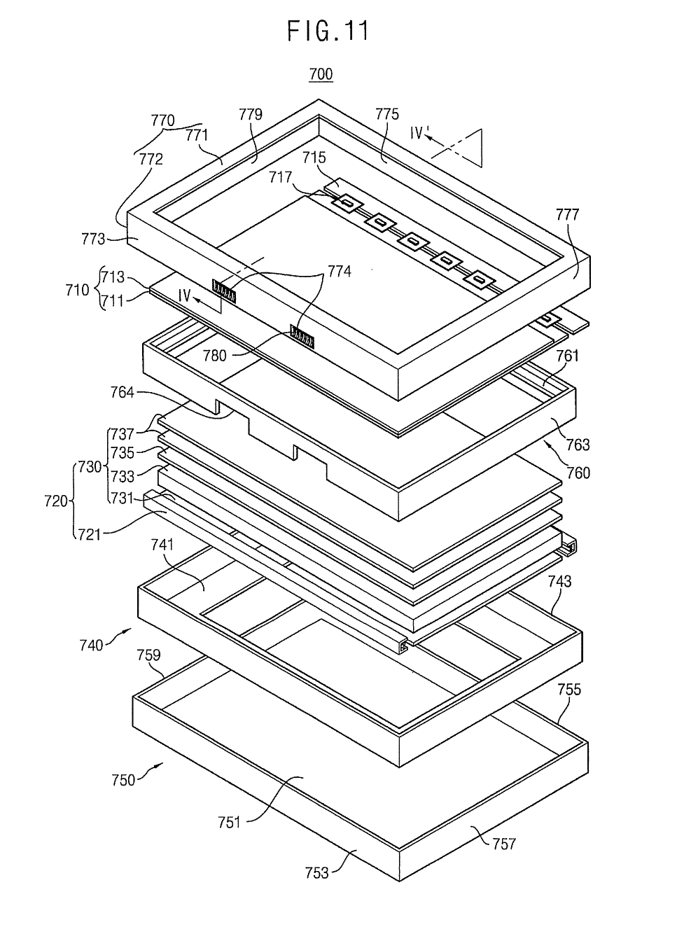

FIG. 10 is a cross-sectional view illustrating an exemplary display device in accordance with another exemplary embodiment of the present invention.

Referring to FIG. 10, a display device 600 includes a display panel 610, a backlight assembly, a middle mold frame, a PCB 615, a connecting film 617, a contact member 619, a first covering member 650, and a second covering member. The display device 600 is substantially the same as the display device 500 in FIGS. 7 to 9 except for the position of the PCB 615.

The display panel 610 displays an image based on light emitted from the backlight assembly. The display panel 610 includes a first substrate 611, a second substrate 613 facing the first substrate 611, and a liquid crystal layer (not shown) disposed between the first substrate 611 and the second substrate 613. A display area and a peripheral area surrounding the display area are defined on the display panel 610.

The backlight assembly is disposed at the rear surface of the display panel 610, and emits light into the rear surface of the display panel 610. The backlight assembly includes a light source and an optical unit 630.

The light source includes a plurality of lamps 623 emitting the light. The lamps 623, for example, may be a cold cathode fluorescent lamp (“CCFL”). While lamps are described for the light source, it should be understood that alternate light sources, such as, but not limited to, light emitting diodes (“LEDs”), ambient light, etc. may be employed in the display device 600.

The optical unit 630 is disposed between the lamps 623 and the display panel 610. The optical unit 630 improves optical characteristics of the light emitted from the lamps 623, and emits the light into the rear surface of the display panel 610. The optical unit 630 includes a diffusive plate 631, a diffusive sheet 633, and two light condensing sheets 635 and 637.

The diffusive plate 631, diffusive sheet 633, and the light condensing sheets 635 and 637 are laminated, in sequence. The diffusive plate 631 diffuses the light emitted by the lamps 623, and emits light in which the brightness uniformity is improved. The diffusive sheet 633 diffuses the light emitted from the diffusive plate 631, and emits light in which the brightness uniformity is improved. The condensing sheets 635 and 637 improve the front brightness of the light exiting from the diffusive sheet 633, and emit light in which the luminance is improved when viewed on a plane.

The first covering member 650 receives the backlight assembly and the display panel 610. The first covering member 650 includes a first supporting part 651 and a first sidewall part.

For example, the first supporting part 651 covers the rear surface of, or portions of, the rear surface of the backlight assembly. Hereinafter, the first covering member 650 will be referred to as ‘the bottom chassis’, and the first supporting part 651 will be referred to as ‘the bottom plate’.

The lamps 623 are disposed on the bottom plate 651. The bottom plate 651 has a substantially rectangular shape or other shape corresponding to a shape of the display panel 610.

The first sidewall part of the bottom chassis 650 is extended along a side of the display panel 610 and the backlight assembly. The first sidewall part includes first and second sidewalls 653, 655, and third and fourth sidewalls (not shown) extended from four edges of the bottom plate 651. The first, second, third, and fourth sidewalls of the bottom chassis 650 are formed substantially perpendicular to the bottom plate 651, and support the optical unit 630.

The display device 600 may further include a middle mold frame. The middle mold frame covers edges of the optical unit 630, and is combined with the bottom chassis 650. The middle mold frame includes a supporting plate and a combining part. The supporting plate has a substantially rectangular shape, and presses edges of the optical unit 630. Stepped portions are formed at the supporting plate. The display panel 610 is disposed at the stepped portions of the supporting plate. The combining part is extended from the supporting plate along the first, second, third and fourth sidewalls of the bottom chassis 650.

The display device 600 further includes a printed circuit board (“PCB”) 615, a connecting film 617, and a contact member 619.

The second covering member receives the backlight assembly and display panel 610. The second covering member includes a second supporting part 671, a second sidewall part, and a plurality of contact parts 680.

The second supporting part 671 faces the bottom plate 651 of the bottom chassis 650, and supports the display panel 610 and the backlight assembly. For example, the second supporting part 671 covers the peripheral area of the display panel 610. Hereinafter, the second covering member will be referred to as the ‘top chassis’.

The second sidewall is extended from the second supporting part 671 along the first sidewall part of the bottom chassis 650. The second sidewall part includes first and second sidewalls 673, 675, and third and fourth sidewalls (not shown) corresponding to the first, second, third, and fourth sidewalls of the first sidewall part of the bottom chassis 650. The contact member 619 disposed at the PCB 615 contacts an inside upper portion of the second sidewall 675.

The contact parts 680 are extended from the edge of an opening in the first sidewall 673 of the top chassis toward the first sidewall 653 of the bottom chassis 650. Each contact part 680 is bent for a plurality of times, and contacts the first sidewall 653. The contact part 680 includes a supporting protrusion 681, a contact protrusion 683, and a guide protrusion 685.

The contact parts 680 and the PCB 615 formed in the second covering member are disposed at the first sidewall part of the first bottom chassis 650. Therefore, when the contact parts 680 and the PCB 615 are disposed at the same position of the first sidewall part, the thickness of the display device 600 may be increased.

Thus, the contact parts 680 and the PCB 615 are disposed at the different sidewalls of the bottom chassis 650 from each other. The contact parts 680 are formed at the first sidewall 673 of the top chassis. The first sidewall 673 of the second covering member corresponds to the first sidewall 653 of the bottom chassis 650.

The connecting film 617 is bent along a supporting plate of the middle mold frame and a connecting part. The PCB 615 is disposed at the connecting part corresponding to the second sidewall 655 of the bottom chassis 650. Therefore, interference between the contact parts 680 and the PCB 615 is prevented, and the thickness of the display device 600 may be reduced.

FIG. 11 is an exploded perspective view illustrating an exemplary display device in accordance with another exemplary embodiment of the present invention.

Referring to FIG. 11, a display device 700 includes a display panel 710, a backlight assembly 720, a first covering member 750, and a second covering member 770.

The display panel 710 and the first covering member 750 are substantially the same as the display panel 510 and the first covering member 550 in FIGS. 7 to 9.

The first covering member 750 includes a bottom plate 751 and a sidewall part including first, second, third, and fourth sidewalls 753, 755, 757, and 759.

The display panel 710 may include a first substrate 711, a second substrate 713, and a liquid crystal layer there between.

The backlight assembly 720 is disposed at a rear surface of the display panel 710 and emits light into the back side of the display panel 710. The backlight assembly 720 includes a light source 721 and an optical unit 730.

The display device 700 may further include a bottom mold frame 740. The bottom mold frame 740 receives the backlight assembly 720. The bottom mold frame 740 includes a bottom part 741 and a cover part 743. An opening to reduce the volume and weight is formed at the bottom part 741. The cover part 743 is extended from a peripheral area of the bottom part 741. The bottom mold frame 740 includes resin having electrical conductivity, and is received in the first covering member 750 having metal. Hereinafter, the first covering member 750 will be referred to as the ‘bottom chassis’ 750.

The light source 721 includes a lamp 723 and a lamp reflector 725. The lamp 723 is disposed in each of the cover parts 743 facing the bottom mold frame 740. The lamp reflector 725 surrounds the lamp 723, and reflects incident light that is from the lamp 723 toward an inside of the bottom mold frame 740.

The optical unit 730 guides the light that is from the light source 721 toward the display panel 710. The optical unit 730 includes a reflection sheet 731, a light guide plate 733, a diffusive sheet 735, and two light condensing sheets 737. The reflective sheet 731, the light guide plate 733, the reflective sheet 735, and the light condensing sheets 737 are laminated on the bottom part 741, in sequence.

The light guide plate 733 guides the incident light from the lamp 723 toward an upper surface of the light guide plate 733. The light guide plate 733 includes polymer resin having various characteristics such as excellent light transmittance, thermal endurance, chemical endurance and mechanical strength. Examples of the polymer resin that can be used for the light guide plate 733 include polymethylmethacrylate, polyamide, polyimide, polypropylene and polyurethane and so on.

The reflective sheet 731 reflects leaked light that leaks through the lower surface of the light guide plate 733 toward the lower surface of the light guide plate 733. The diffusive sheet 735 improves the uniformity of the light exiting from the upper surface of the light guide plate 733. The condensing sheets 737 improve the brightness of the light exiting from the diffusive sheet 735 when viewed on a plane.

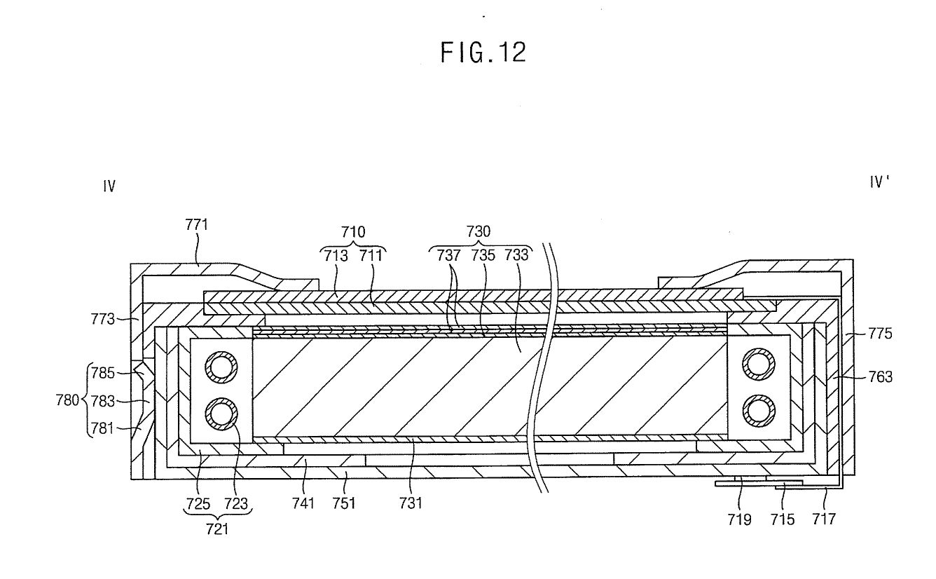

FIG. 12 is a cross-sectional view taken along line IV-IV′ of the exemplary display device in FIG. 11.

Referring to FIGS. 11 and 12, the display device 700 may further include a middle mold frame 760. The middle mold frame 760 is substantially the same as the middle mold frame 560 in FIGS. 8 and 9 except for a groove 764 formed on a connecting part 763.

The middle mold frame 760 includes a supporting plate 761 supporting the display panel 710 and a connecting part 763 extended from the supporting plate 761 along a first sidewall part of the bottom chassis 750. A groove 764 is formed on the connecting part 763 corresponding to a first sidewall 753 of the bottom chassis 750. The first sidewall 753 is partially exposed through the groove 764.

The display device 700 may further include a PCB 715, a connecting film 717, and a contact member 719. The PCB 715, the connecting film 717, and the contact member 719 are substantially the same as the PCB 515, the connecting film 517, and the contact member 519 in FIGS. 8 and 9 except for locations.

The connecting film 717 is electrically connected to a first substrate 711 of the display panel 710, and is extended along the connecting part 763 and the rear surface of the bottom plate 751 of the bottom chassis 750 corresponding to a second sidewall 755 of the bottom chassis 750. The PCB 715 is disposed on the rear surface of the bottom plate 751. The contact member 719 contacts the bottom plate 751, as shown in FIG. 12. Therefore, the PCB 715 is electrically grounded to the bottom chassis 750.

The second covering member 770 covers a peripheral area of the display panel 710, and is combined with the middle mold frame 760 or the bottom chassis 750. The second covering member 770 is substantially the same as the second covering member 570 in FIGS. 7 to 9. The second covering member 770, hereinafter referred to as the ‘top chassis’ 770 includes a supporting part 771 and a sidewall part 772. The sidewall part 772 includes first, second, third, and fourth sidewalls 773, 775, 777, and 779.

An opening 774 is formed in the second covering member 770 corresponding to the first sidewall 753 of the bottom chassis 750, i.e. within the first sidewall 773 of the top chassis 770. The contact parts 780 are extended from edges of the opening 774. The contact parts 780 include a supporting protrusion 781, a contact protrusion 783, and a guide protrusion 785.

The supporting protrusion 781 is inclined with respect to the first sidewall 773, and is extended from the lower edge of the opening 774 toward the first sidewall 753 of the bottom chassis 750. The contact protrusion 783 is extended along the first sidewall 753. The contact protrusion 783 is contacted to the first sidewall 753 exposed through the groove 764 formed in the middle mold frame 760. Therefore, the top chassis 770 and the bottom chassis 750 are physically and electrically connected via the contact parts 780.

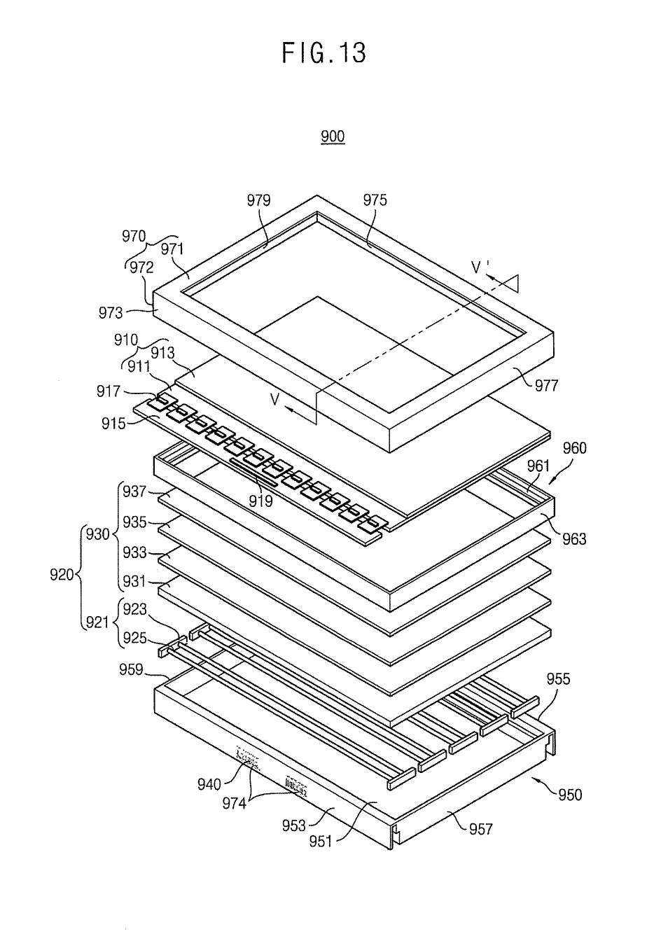

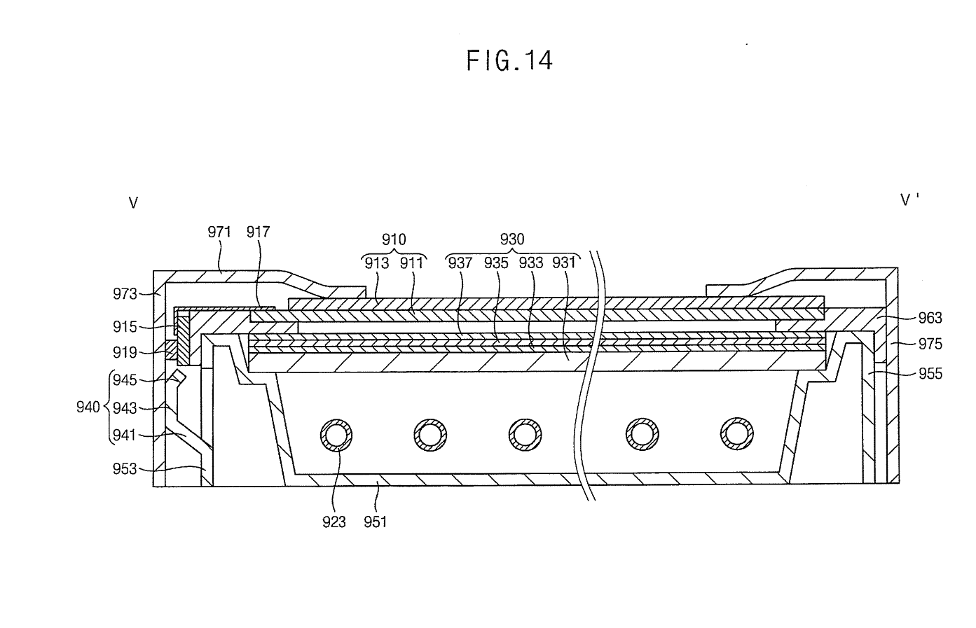

FIG. 13 is an exploded perspective view illustrating an exemplary display device in accordance with another exemplary embodiment of the present invention. FIG. 14 is a cross-sectional view taken along line V-V′ of the exemplary display device in FIG. 13.

Referring to FIGS. 13 and 14, a display device 900 includes a display panel 910, a PCB 915, a connecting film 917, a contact member 919, a backlight assembly 920, a first covering member 970 and a second covering member 950.

The display panel 910, the PCB 915, the connecting film 917, the contact member 919, and the backlight assembly 920 are substantially the same as the display panel 510, the PCB 515, the connecting film 517, the contact member 519, and the backlight assembly 520 in FIGS. 7 to 9.

The display panel 910 includes a first substrate 911, a second substrate 913, and a liquid crystal layer (not shown) disposed there between.

The backlight assembly 920 includes a light source 921 and an optical unit 930. The light source 921 includes lamps 923 and lamp holders 925. The optical unit 930 includes a diffusive plate 931, a diffusive sheet 933, and light condensing sheets 935.

The first covering member 970 is substantially the same as the second covering member 570 in FIGS. 7 to 9 except for an absence of the opening and the contact parts. Hereinafter, the first covering member 970 will be referred to as ‘top chassis’. The top chassis 970 includes supporting part 971 and sidewall part 972. The sidewall part 972 includes first, second, third, and fourth sidewalls 973, 975, 977, and 979.

A middle mold frame 960 is further provided including a supporting plate 961 and a combining part 963.

The second covering member 950 is substantially the same as the covering member 150 in FIGS. 4 to 6. The second covering member 950 includes a second supporting part 951 and a second sidewall part. Hereinafter the second covering member 950 will be referred to as ‘a bottom chassis’, and the second supporting part 951 will be referred to as ‘a bottom plate’.

The second sidewall part includes first, second, third and fourth sidewalls 953, 955, 957, and 959. Openings 974 are formed at the first sidewall 953. Contact parts 940 are protruded from edges of the openings 974 to an outside of the receiving space defined by the bottom plate 951 and the first, second, third, and fourth sidewalls 953, 955, 957, and 959.

The contact parts 940 include a supporting protrusion 941, a contact protrusion 943, and a guide protrusion 945. The supporting protrusion 941 is inclined with respect to the first sidewall 953, and is extended from the lower edge of the opening 974 toward the first sidewall 973. The contact protrusion 943 is extended from the supporting protrusion 941 along the inside of the first sidewall 973 toward the upper portion of the first sidewall 973, and is contacted with the first sidewall 973. The guide protrusion 945 is inclined with respect to the first sidewall 953 of the second sidewall part, and is extended from the contact protrusion 943 toward the first sidewall 953. Therefore, the top chassis 970 and the bottom chassis 950 are physically and electrically connected via the contact parts 940.

A method of grounding a static charge or an electromagnetic wave applied to a covering member of a display device is thus made possible using the covering member with contact members as described above. The method may include integrally forming a plurality of contact members from an opening in a sidewall part of the covering member, the plurality of contact members formed with a plurality of bends and resiliency with respect to the sidewall part, combining the covering member with an electrically conductive component of the display device, and physically and electrically contacting the covering member to the component through at least the plurality of contact members. The covering member and the component may enclose a display panel and a backlight assembly of the display device therein.

According to the present invention, covering members for a display device such as a top chassis or a bottom chassis are formed integrally. The covering members for the display device such as the top chassis and the bottom chassis may be grounded without an additional grounding member. Therefore, the number of components of the display device may be reduced.

Moreover, contact parts are directly contacted with the top chassis or the bottom chassis in the assembling process of the top chassis and the bottom chassis. Therefore, an assembly process of the display device is simplified.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A covering member for a display device, the covering member comprising:
a supporting part extended along an upper surface of the display device;
a sidewall part extended from the supporting part along a side surface of the display device, the sidewall part having an opening; and
a plurality of contact parts inclined with respect to the sidewall part and extended from an edge of the opening, each of the contact parts bent a plurality of times.

2. The covering member of claim 1, wherein the supporting part covers edges of a display panel of the display device.

3. The covering member of claim 2, wherein the opening is formed between an upper portion of the sidewall part connected with the supporting part and a lower portion of the sidewall part opposite to the upper portion of the sidewall part,
and the contact parts are extended from an upper edge of the opening adjacent to the upper portion of the sidewall part or from a lower edge of the opening adjacent to the lower portion of the sidewall part.

4. The covering member of claim 1, wherein each of the contact parts comprises:
a supporting protrusion inclined with respect to the sidewall part and extended from an edge of the opening to an inside of a receiving space defined by the supporting part and the sidewall part;
a contact protrusion extended from the supporting protrusion and extending substantially parallel with the sidewall part; and
a guide protrusion inclined with respect to the sidewall part and extended toward the sidewall part.

5. The covering member of claim 1, wherein the supporting part covers a rear surface of a backlight assembly of the display device.

6. The covering member of claim 5, wherein each of the contact parts comprises:
a supporting protrusion inclined with respect to the sidewall part and extended from an edge of the opening to an outside of a receiving space defined by the supporting part and the sidewall part;
a contact protrusion extended from the supporting protrusion and extending substantially parallel with the sidewall part; and
a guide protrusion inclined with respect to the sidewall part and extended from the contact protrusion toward the sidewall part.

7. The covering member of claim 1, wherein the plurality of contact parts are integrally formed with the sidewall part and have resiliency with respect to the sidewall part.

8. A display device comprising:
a display panel including a display area and a peripheral area surrounding the display area;
a backlight assembly supplying light into a rear surface of the display panel;
a first covering member receiving the display panel and the backlight assembly, the first covering member including:
a first supporting part supporting the display panel and the backlight assembly; and
a first sidewall part extended from the first supporting part along sides of the display panel and the backlight assembly; and
a second covering member receiving the display panel and the backlight assembly, the second covering member including;
a second supporting part corresponding to the first supporting part, and supporting the display panel and the backlight assembly;
a second sidewall part extended from the second supporting part along the first sidewall part and having an opening; and
a plurality of contact parts extended from an edge of the opening, each of the contact parts bent a plurality of times to contact the first sidewall part.

9. The display device of claim 8, wherein the first supporting part covers a rear surface of the backlight assembly,
and the second supporting part and the second sidewall part cover the peripheral area of the display panel and the first sidewall part, respectively.

10. The display device of claim 9, further comprising:
a printed circuit board driving the display panel; and
a contact member disposed on the printed circuit board, the contact member contacting the first covering member or the second covering member.

11. The display device of claim 10, wherein each of the contact parts comprises:
a supporting protrusion inclined with respect to the second sidewall part and extended from an edge of the opening toward the first sidewall part;
a contact protrusion extended from the supporting protrusion and extending substantially parallel with the first sidewall part to make a surface contact with the first sidewall part; and
a guide protrusion extended from the contact protrusion toward the second sidewall part.

12. The display device of claim 11, wherein the backlight assembly comprises:
a light source disposed on the first supporting part; and
an optical unit supported by the first sidewall part.

13. The display device of claim 12, further comprising a middle mold frame covering a peripheral area of the optical unit and extended between the first sidewall part and the second sidewall part.

14. The display device of claim 10, wherein the backlight assembly comprises:
a light guide plate disposed on the first supporting part;
a light source disposed at a side of the light guide plate; and
an optical unit disposed on the light guide plate.

15. The display device of claim 8, wherein the second supporting part covers a rear surface of the backlight assembly,
and the first supporting part and the first sidewall part cover the peripheral area of the display panel and the second sidewall part, respectively.

16. The display device of claim 15, wherein each of the contact parts comprises:
a supporting protrusion inclined with respect to the second sidewall part and extended from an edge of the opening toward the first sidewall part;
a contact protrusion extended substantially parallel to the first sidewall part and making a surface contact with the first sidewall part; and
a guide protrusion extended from the contact protrusion toward the second sidewall part.

17. The display device of claim 8, wherein the plurality of contact parts are integrally formed with the second sidewall part and have resiliency with respect to the second sidewall part.

18. The display device of claim 8, wherein the first covering member and the second covering member are physically and electrically connected to each other through at least the plurality of contact parts and a static charge or an electromagnetic wave applied to at least one of the first covering member and the second covering member is grounded.

19. A method of grounding a static charge or an electromagnetic wave applied to a covering member of a display device, the method comprising:
integrally forming a plurality of contact members from an opening in a sidewall part of the covering member, the plurality of contact members formed with a plurality of bends and resiliency with respect to the sidewall part;
combining the covering member with an electrically conductive component of the display device; and
physically and electrically contacting the covering member to the component through at least the plurality of contact members.

20. The method of claim 19, wherein combining the covering member with an electrically conductive component includes enclosing a display panel and a backlight assembly of the display device between the covering member and the component.
